(19) United States
(12) Patent Application Publication
(10) Pub. No.: US 2017/0272428 A1
(43) Pub. Date: Sep. 21, 2017

(54) Method for validating the identity of a user by using geo-location and biometric signature stored in device memory and on a remote server

(71) Applicant: Thien Van Pham, Lacey, WA (US)

(72) Inventor: Thien Van Pham, Lacey, WA (US)

(73) Assignees: Thien Pham, Lacey, WA (US); Wayne Taylor, Chandler, AZ (US); Synergex Group, Greenwhich, CT (US)

(21) Appl. No.: 15/071,487

(22) Filed: Mar. 16, 2016

(51) Int. Cl. H04L 29/06

(52) U.S. Cl. CPC H04L 63/0861; H04L 63/107

(57) ABSTRACT

Method for validating the identity of a user by using geo-location and biometric signature stored in device memory and on a remote server.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates generally to smart devices that include embedded integrated circuit chips. More specifically, the present invention relates to a smart device operating on a multi-application operating system to review biometric data and Global Positioning System (“GPS”) coordinates to authenticate identity in order to grant or deny a user instant or real-time access to secured information, wherein review of the biometric data and GPS coordinates takes place on the smart device with a remote validation with a verification server.

### BACKGROUND OF THE INVENTION

Smart devices include embedded integrated circuit chips which can process data. The embedded integrated circuits typically include a processor, microprocessor or central processing unit, random access memory or programmable read-only memory, read-only memory, electrically erasable programmable read-only-memory, and Input/Output.

The processors in smart devices can be programmed like any other computer to perform desired functions. Smart devices read GPS coordinates from onboard GPS chips. A program can be run independently or collectively with other programs to perform a task. Smart devices runs a multi-application operating system that enables the collection of biometric data to carry a variety of applications, for example, contactless payment, internet authentication and loyalty, national identity with biometric signature, ePassport with biometrics, healthcare and military base, and network access control.

Generally, biometrics refers to the science of using automated methods for recognizing biological, physiological, or behavioral characteristics that are absolutely unique to individuals. Recognizing characteristics unique to individuals typically involves methods to capture, store, and examine the characteristics for identification of an individual by automated means.

The biometric application captures, examines, and verifies the biometric sample including a check for clarity including similarity and completeness. If the biometric sample does not meet standards, a request is made to resubmit another biometric sample.

The GPS verification application retrieves the current GPS coordinate of the device and verifies the GPS coordinates with a set of GPS coordinates for proximities. If the current GPS coordinate does not meet the standards, the request is deny.

Biometric signature verification on the device or to a remote server alone is not enough to prevent identity theft. What is needed is a method of using biometric signature verification and GPS verification to validate the identity of a user on the device and to a remote server.

### BRIEF SUMMARY OF THE INVENTION

The invention comprise of a software that resides on a smart device that takes a sample biometric signature and GPS coordinate and compare them to a set of biometric signatures and a set of GPS coordinates in memory. If the sample biometric signature and GPS coordinate meet standards, the biometric signature and GPS coordinate is then validated with a remote server for authenticity before storing the biometric signature and GPS coordinate in memory on the smart device and on a data server on the Internet.

In a typical application, the user is logging into an application or accessing a feature from their smart device. The user uses the available biometric capture input device such as a finger print reader, facial scanner, camera, the touch screen of the smart device to sign their signature, or any other biometric reader to capture his/her biometric signature. Once the biometric signature is collected, the application then gets the GPS coordinate of the device. The application then compares the biometric signature with a set of biometric signatures store in memory on the smart device using any biometric signature verification software. If successful, the application verifies the GPS coordinate of the smart device to ensure it meets the standard using any GPS coordinate verification software. If successful, the application then compares the biometric signatures and GPS coordinates on the device with the remote server. If the comparison is successful, the application allows the user access to their intended application or to conduct a transaction of the intended application.

### BRIEF DESCRIPTION OF THE SEVERAL VIEWS OF THE DRAWING

FIG. 1 illustrates the process of the present invention.

### DETAILED DESCRIPTIONS OF THE INVENTION

The invention is now described in detail with reference to an embodiment thereof as illustrated in the accompanying drawing. In the following description, numerous specific details are set forth in order to provide thorough understanding of the present disclosure. It is apparent, however, to one skilled in the art, that the present discloser may be practiced without some or all of these specific details. In other instances, well known process steps and/or structures have not been described in detail in order not to unnecessarily obscure the present disclosure. In addition, while the disclosure is described in conjunction with the particular embodiment, it should be understood that this description is not intended to limit the disclosure to the described embodiment. To the contrary, the description is intended to cover alternatives, modifications, and equivalents as may be included within the spirit and scope of the disclosure as defined by the appended claims.

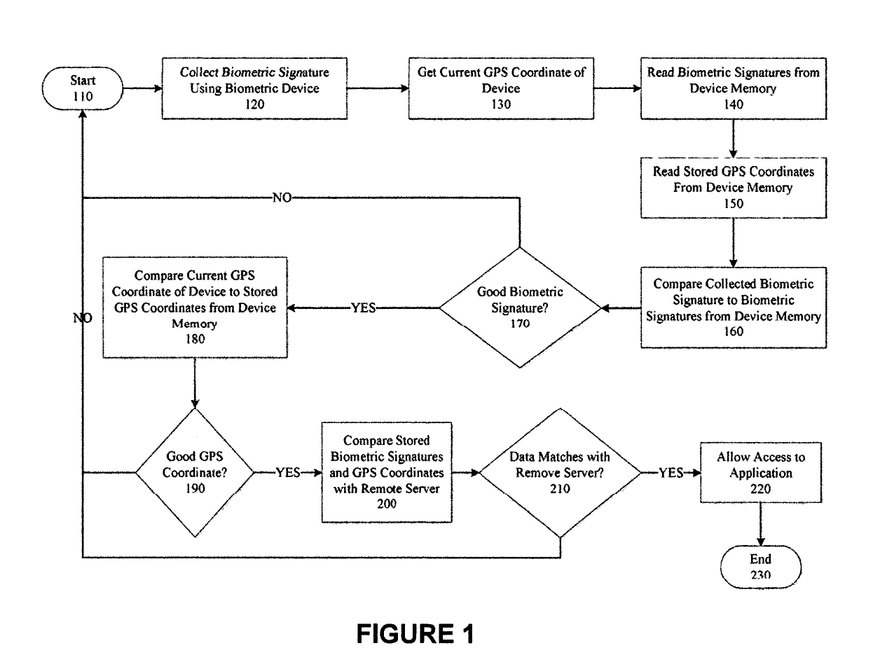

FIG. 1 illustrates the process of the present invention, which is a computer program. First the user starts their application on their smart device. The user opens an application such as a banking application, an ecommerce application, or any other application that requires authenticating the individual. The present invention begins at Step 110. The program now waits for the user to input their biometric signature, either a finger print, facial image, signature capture by the smart device touch screen, or photo snap shot using the smart device camera. Once the biometric sample is collected at Step 120, the program continues to Step 130, where the program requests the user for their current GPS coordinate. The program then proceeds to Step 140, where the program then reads the stored biometric signatures in memory on the smart device and continues to Step 150, where the program reads the stored GPS coordinates in memory on the smart device. The program then proceeds to Step 160, where it uses special comparison programs to compare the biometric sample collected in Step 120 with the set of biometric samples read from Step 140. At Step 170, if the biometric comparison of the biometric sample to the stored biometric signatures in memory meets a certain threshold criteria, the program proceeds to Step 180. If not, the program proceeds to Step 110 and starts the process again. At Step 180, the program uses a special GPS comparison program to compare the GPS coordinate collected at Step 130 with the set of GPS coordinates read from memory at Step 150. At Step 190, if the GPS comparison of the current GPS coordinate to the set of stored GPS coordinates stored in device memory meets a certain threshold criteria, the program proceeds to Step 200 where the program compares the set of biometric signatures and GPS coordinates stored on device to a set of biometric signatures and GPS coordinates stored on a remote data server. If the program was not successful at Step 190, the program proceeds to Step 110 and starts the process again. At Step 210, if the comparison of the biometric sample to the set of stored biometric signatures on a remote data server and the comparison of the current GPS coordinate to the set of stored GPS coordinates on a remote data server meet a certain threshold criteria, the program proceeds to Step 220 where the program stores the collected biometric signature of Step 140 and the GPS coordinate collected of Step 150 to the smart device memory and to a data server on the Internet. At Step 220, the program returns a success and gives access to the function the user is requesting for and continues to Step 230 and the program ends.

What is claimed is:

1. A method for validating the identity of a user by using geo-location and biometric signature stored in device memory and on a remote server comprising the steps of:
(a) comparing the sample biometric signature with a set of biometric signatures stored in device memory
(b) comparing the current GPS coordinate of the device with the set of GPS coordinates stored in device memory
(c) comparing the set of biometric signatures stored in device memory to a set of biometric signatures stored on a remote server on the Internet
(d) comparing the set of GPS coordinates stored in device memory to a set of GPS coordinates stored on a remote server on the Internet
(e) storing the sample biometric signature and current GPS coordinate to device memory and on the Internet

2. The method of claim 1, wherein the sample biometric signature and the reference signatures are handwritten signatures, facial images, fingerprint scans, or voice prints.

3. The method of claim 1, wherein the current GPS coordinate and reference GPS coordinates are coordinates transmitted by the smart device.

4. The method of claim 1, wherein smart devices are used to input biometric samples and GPS coordinates.
